(19) United States
(12) Patent Application Publication
(10) Pub. No.: US 2016/0073190 A1
(43) Pub. Date: Mar. 10, 2016

(54) HEADPHONES WITH JUNCTION RECEPTACLE

(71) Applicant: Travis J. Reid, Santa Clara, CA (US)

(72) Inventor: Travis J. Reid, Santa Clara, CA (US)

(21) Appl. No.: 14/478,256

(22) Filed: Sep. 5, 2014

(51) Int. Cl. H04R 1/10; H04R 1/06; H04R 1/00; H01R 24/58; H01R 13/72

(52) U.S. Cl. CPC H04R 1/1033; H01R 24/58; H01R 13/72; H04R 1/00; H04R 1/06

(57) ABSTRACT

Headphones include a plug connector and a junction receptacle. The junction receptacle has a socket that fits the plug connector. A first cable connects the plug connector to the junction receptacle. Headphones are connected by cables to the junction receptacle.

### BACKGROUND

Headphones are composed of a pair of small loud speakers that are designed to be held in place next to the ears of a user. Headphones are connected by wire or wirelessly to a signal source. The signal source can be a personal musical device, a mobile phone, a CD player or some other type of portable or non-portable device.

Earbuds are very small headphones, or earphones, that are fitted directly in the outer ear and face into the ear canal. They often include foam pads for comfort. Earbuds provide very little acoustic isolation so users of earbuds can often hear ambient noise from their surroundings. In-ear headphones are typically placed into the ear canal allowing for more acoustic isolation.

### BRIEF DESCRIPTION OF THE DRAWINGS

FIG. 1 shows a set of headphones with a junction receptacle in accordance with an implementation.

FIG. 2 shows additional detail of the junction receptacle shown in FIG. 1 in accordance with an implementation.

FIG. 3 shows a cross-sectional view of the junction receptacle shown in FIG. 1 in accordance with an implementation.

FIG. 4 shows additional detail of the junction receptacle shown in FIG. 1 in accordance with an implementation.

FIG. 5 shows a necklace formed by the set of earbuds shown in FIG. 1 in accordance with an implementation.

### DESCRIPTION OF THE EMBODIMENT

A junction in a set of headphones allows the headphones to be worn as a necklace and serves to allow multiple headphones to be connected together.

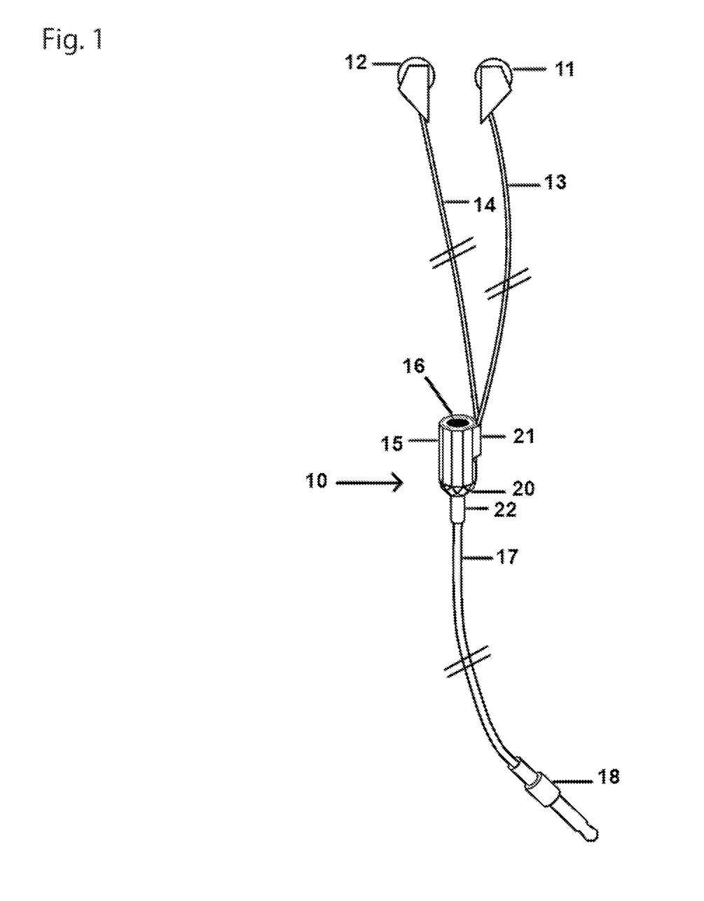

FIG. 1 shows headphones 10. Headphones 10 include a plug connector 18. For example, plug connector 18 is a 3.5 millimeter (mm) stereo mini jack plug. A cable 17 connects connector 18 to a bottom portion 20 of a junction receptacle 15. A sleeve 22 protects the connection of cable 17 to bottom portion 20 of junction receptacle. A typical length for cable 17 is twenty-nine inches.

Junction receptacle 15 includes a socket 16. For example, socket 16 is a 3.5 mm stereo mini jack socket. Junction receptacle also includes a protector 21 to which is attached a cable 13 and a cable 14. An earphone 11 is attached to cable 13 and an earphone 12 is attached to cable 14. For example, earphone 11 and earphone 12 are earbuds. Alternatively, earphone 11 and earphone 12 are in ear headphones or another type of headphones. A typical length for cable 13 and cable 14 is twelve inches.

Socket 16 is electrically connected to plug connector 18 so that socket 16, cable 17 and plug 18 function as a male-to-female adapter. This allows another set of headphones, or even another device, that is plugged into socket 16 to receive signals from connector plug 18. Earphone 11 through cable 13, junction receptacle 15 and cable 17 is also electrically connected to connector plug 18, allowing earphone 11 to receive signals from connector plug 18. Likewise, earphone 12 through cable 14, junction receptacle and cable 17 is also electrically connected to connector plug 18, allowing earphone 12 to receive signals from connector plug 18.

For example, within cable 17 two insulated copper wires (e.g., for left channel and ground) continue through junction receptacle 15 and cable 13 to earphone 11 to establish electrical connection between connector plug 18 and earphone 11. Likewise, two insulated copper wires (e.g., for right channel and ground) continue through junction receptacle 15 and cable 14 to earphone 12 to establish electrical connection between connector plug 18 and earphone 11. Also, for example, three insulated copper wires (e.g., for left channel, right channel and ground) connect plug connector 18 to socket 16.

In an alternate embodiment, three insulated copper wires (e.g., for left channel, right channel and ground) connect plug connector 18 to socket 16. Within cable 13 two insulated copper wires (e.g., for left channel and ground) establish electrical connection between socket 16 and earphone 11. Also, within cable 14 two insulated copper wires (e.g., for right channel and ground) establish electrical connection between socket 16 and earphone 12.

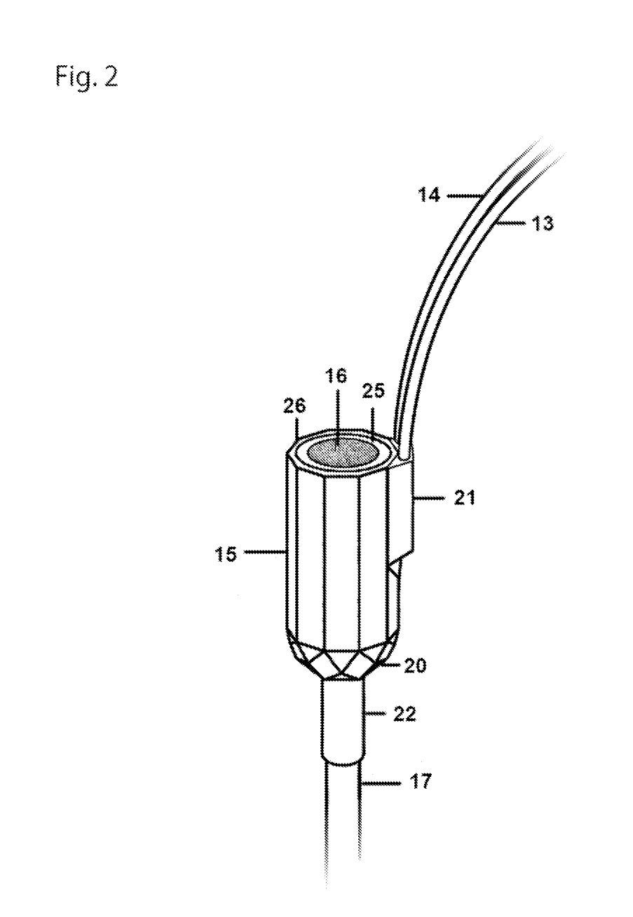

FIG. 2 shows additional detail of junction receptacle 15. Socket 16 is shown to include a metal ring 25 and plastic outside portion 26.

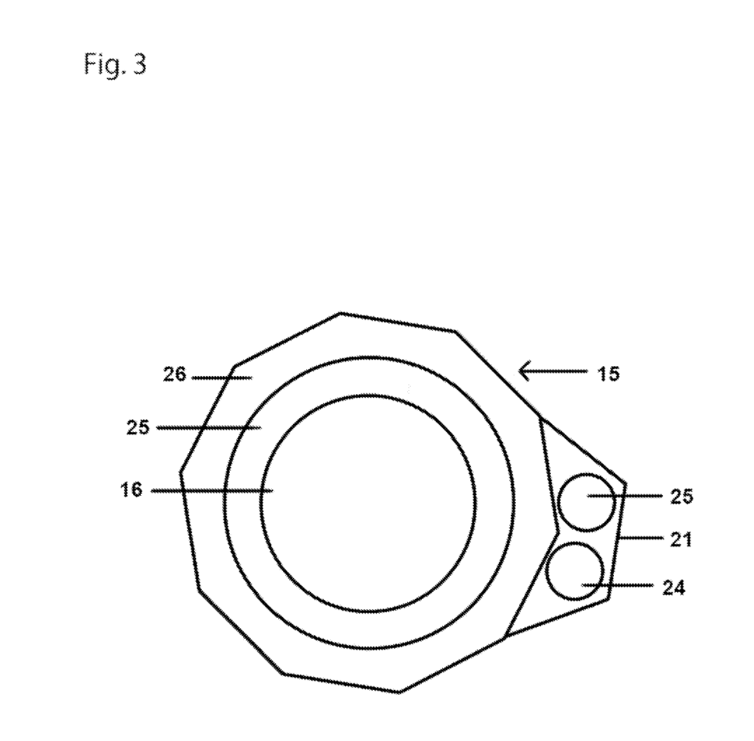

FIG. 3 shows a cross-sectional view of junction receptacle 15. In addition to showing metal ring 25 and plastic outside portion 26, FIG. 3 shows a cable section 23 and a cable section 24 within protector 21.

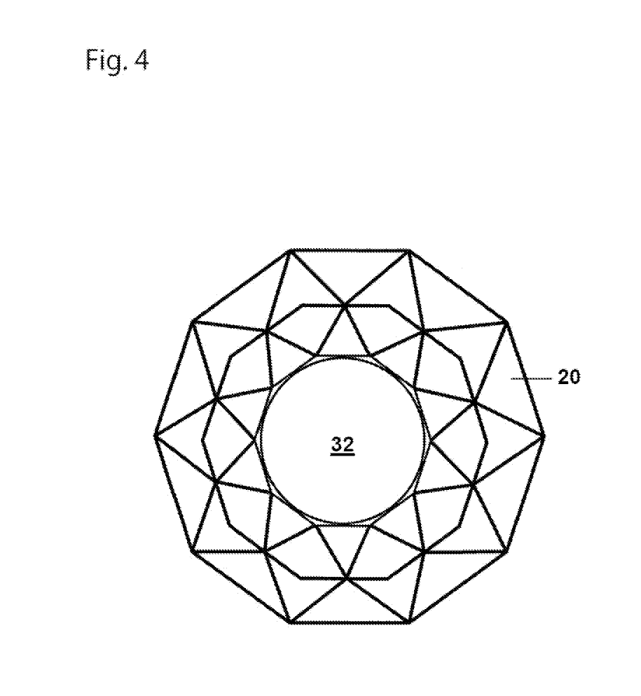

FIG. 4 shows additional detail of bottom portion 20 of junction receptacle 15. Cable 17 enters bottom portion 20 of junction receptacle 15 at an area 32 of bottom portion 20 of a junction receptacle 15.

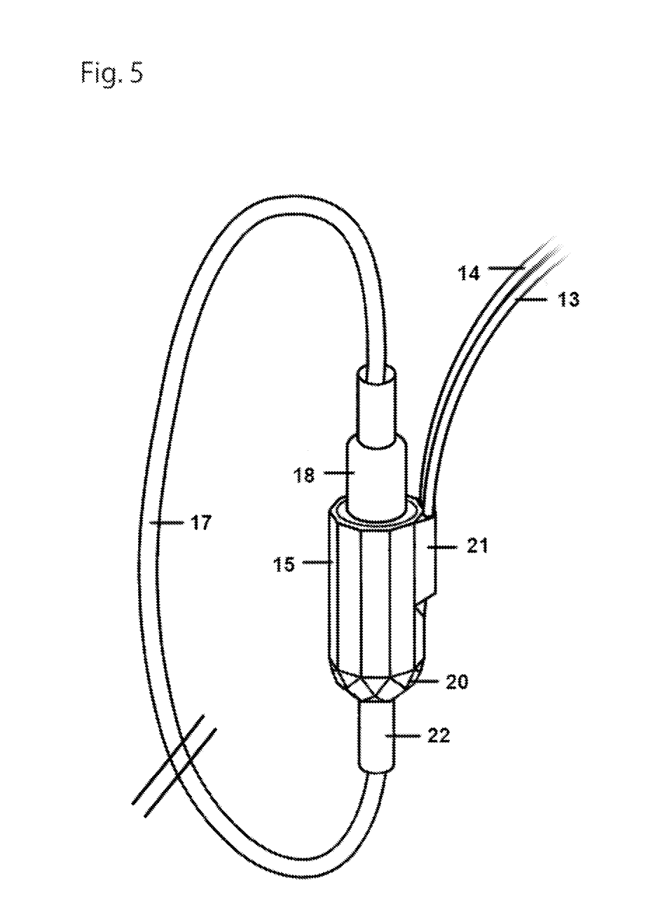

FIG. 5 shows connector plug 18 inserted into socket 16. This allows cable 17 to function as a necklace for easy transportation.

While the embodiments herein are for headphones where socket 16 is a 3.5 mm stereo mini jack socket and plug connector 18 is a 3.5 mm stereo mini jack plug, other size plugs and sockets may be utilized. For example, socket 16 can be a 2.5 mm stereo mini jack socket and plug connector 18 can be a 2.5 mm stereo mini jack plug. Likewise, socket 16 can be a one quarter inch jack socket and plug connector 18 can be a one quarter inch jack plug. Other sizes of jack sockets and plug connectors can also be used.

Also, use of earphones are illustrative. Other types of headphones other than ear phones, can be used. For example, a light weight set of headphones could replace ear phones 11 and 12.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed is:

1. Headphones comprising:
a plug connector;
a junction receptacle, the junction receptacle having a socket that fits the plug connector;
a first cable that connects the plug connector to the junction receptacle; and,
headphones connected by cables to the junction receptacle;
wherein the plug connector is electrically connected to the junction receptacle through wires within the first cable; and,
wherein the plug connector is electrically connected to the headphones through the cables, the junction receptacle and the first cable.

2. Headphones as in claim 1:
wherein the cables comprise a first cable and a second cable; and,
wherein the headphones comprise a first earbud connected by the second cable to the junction receptacle and a second earbud connected by the third cable to the junction receptacle.

3. Headphones as in claim 1:
wherein the cables comprise a first cable and a second cable; and,
wherein the headphones comprise a first earphone connected by the second cable to the junction receptacle and a second earphone connected by the third cable to the junction receptacle.

4. Headphones as in claim 1:
wherein the cables comprise a first cable and a second cable; and,
wherein the headphones comprise a first in ear headphone connected by the second cable to the junction receptacle and a second in ear headphone connected by the third cable to the junction receptacle.

5. Headphones as in claim 1 wherein the plug connector is a 3.5 millimeter (mm) stereo mini jack plug and the socket is a 3.5 mm stereo mini jack socket.

6. Headphones as in claim 1 wherein the plug connector is a 2.5 millimeter (mm) stereo mini jack plug and the socket is a 2.5 mm stereo mini jack socket.

7. Headphones as in claim 1 wherein the plug connector is a one quarter inch jack plug and the socket is a one quarter inch jack socket.

8. A headphone set comprising:
a plug connector;
a junction receptacle, the junction receptacle having a socket that fits the plug connector;
a first cable that includes wires that electrically connect the plug connector to the junction receptacle;
a first headphone connected by a second cable to the junction receptacle; and,
a second headphone connected by a third cable to the junction receptacle;
wherein two wires extend from the plug connector through the first cable, through the junction receptacle through the second cable to the first headphone; and,
wherein two wires extend from the plug connector through the first cable, through the junction receptacle through the third cable to the second headphone.

9. Headphones as in claim 8:
wherein the first headphone comprises a first earbud connected by the second cable to the junction receptacle and the second headphone comprises a second earbud connected by the third cable to the junction receptacle.

10. Headphones as in claim 8:
wherein the first headphone comprises a first earphone connected by the second cable to the junction receptacle and the second headphone comprises a second earphone connected by the third cable to the junction receptacle.

11. Headphones as in claim 8:
wherein the first headphone comprises a first in ear headphone connected by the second cable to the junction receptacle and the second headphone comprises a second in ear headphone connected by the third cable to the junction receptacle.

12. Headphones as in claim 8 wherein the plug connector is a 3.5 millimeter (mm) stereo mini jack plug and the socket is a 3.5 mm stereo mini jack socket.

13. Headphones as in claim 8 wherein the plug connector is a 2.5 millimeter (mm) stereo mini jack plug and the socket is a 2.5 mm stereo mini jack socket.

14. Headphones as in claim 8 wherein the plug connector is a one quarter inch jack plug and the socket is a one quarter inch jack socket.
